(19) United States
(12) Patent Application Publication
(10) Pub. No.: US 2018/0264301 A1
(43) Pub. Date: Sep. 20, 2018

(54) PORTABLE FIREFIGHTING AGENT DELIVERY SYSTEM

(71) Applicant: Frontline Equipment Technologies, LLC, North Port, FL (US)

(72) Inventors: Keith Grant, North Port, FL (US); Loren Rideout, Sarasota, FL (US)

(21) Appl. No.: 15/983,143

(22) Filed: May 18, 2018

Related U.S. Application Data
(63) Continuation-in-part of application No. 14/302,802, filed on Jun. 12, 2014.

(51) Int. Cl. A62C 31/22; A62C 31/02

(52) U.S. Cl. CPC A62C 31/22; A62C 31/02

(57) ABSTRACT

An extendible firefighting nozzle and supply mechanism for use in penetrating materials and debris for fighting concealed fires in, for example, coal supply, bulk wood chip and combustible grain silo fire incidents. The system includes three primary components to deliver firefighting foam, water and/or inert gas to the fire area. The components include a distribution manifold, a sectional delivery piping extension and interchangeable spray nozzles that are tailored to the specific need. The manifold is a length of piping having handles for the operator to grip and reliably use the system, a hammer cap that allows the user to employ a sledge hammer or impact driver to assist in driving the system into the debris pile or fire area and an output end that interfaces with a nozzle of any number of extension pipes. The interface is modular and threaded using NPTM threading to allow extensions to be added or removed depending on the depth of penetration required.

### CROSS-REFERENCE TO RELATED APPLICATIONS

This application is related to and claims priority from earlier filed U.S. patent application Ser. No 14/302,802, filed Jun. 12, 2014, which claims priority from US Provisional Patent Application No. 61/834,193, filed Jun. 12, 2013.

### BACKGROUND OF THE INVENTION

The present invention relates to a portable firefighting nozzle for delivering firefighting materials into subsurface areas. More specifically, the present invention relates to an extendable nozzle system for penetrating through layers of stored materials, debris or structures to deliver the firefighting materials into subsurface voids.

Various types and sizes of piercing or penetrating nozzles have been developed to permit firefighters to extinguish hidden fires, such as those that may be present behind or in a barrier, such as the walls of a building, or in piles of combustible material such as coal, sawdust or the like. Some of these devices were nothing more than lengths of pipe to which a fire hose could be attached, or were more elaborate structures which included hardened tips that could be driven through a barrier to reach the site of a hidden fire by striking the device with a sledge hammer or the like.

While such devices have performed their intended function with varying degrees of success, most of them have suffered from the disadvantage of not being substantially instantly available for use by the attack firefighters when needed, due to their size and/or the necessity for removing the attack nozzle from its hose line in order to connect the barrier or wall piercing device to the hose line. In other words, so far as is known, most of the devices heretofore developed for extinguishing hidden fires could not be brought into operation without substantial loss of time or shutting down an active fire hose line to permit removal of the attack nozzle and substitution of the wall piercing device therefor.

Extinguishing fires in hidden spaces, while being essential to prevent recurrence after the primary fire has been put out, has heretofore been a time consuming and highly destructive task. This was due to the fact that the extinguishment of hidden fires usually involved the use of hooks, axes, pike poles and the like, to pry or tear away surface materials in order to expose the hidden fire and permit the firefighters to extinguish the same. This technique was also hazardous to the firefighters at the scene.

The majority of penetrating or piercing nozzle devices developed attempt to inject a fine spray mist or fog pattern in an attempt to convert the introduced water droplets into steam as the steam conversion allows for a great deal of heat absorption in a defined area. This practice has been in existence for years and is prevalent in shipboard confined space firefighting. However, when using sub-surface injection of water to fight bulk storage fires, introduction of steam fine mists and water fogs has caused violent explosions as the steam builds up in a contained environment.

Also, in the prior art. many of the devices use a piercing tool that spins or has a dual faced “fog” producing pattern behind the nozzle tip. Further, they must use another device to “punch” a hole for insertion of the applicable tool.

Accordingly, there is a need for a novel and improved fire extinguishing device that overcomes the aforementioned disadvantages and objections of the prior art devices. There is a further need for a novel firefighting device which, in addition to its primary function of piercing a barrier can be employed in digging through bulk material for extinguishing fires hidden thereby or therein.

### BRIEF SUMMARY OF THE INVENTION

In this regard, the present invention provides an extendible firefighting nozzle and supply mechanism for use in penetrating materials and debris for fighting concealed fires in, for example, coal supply, bulk wood chip and combustible grain silo fire incidents. The system includes three primary components to deliver firefighting foam, water and/or inert gas to the fire area. The components include a distribution manifold, a sectional delivery piping extension and interchangeable spray nozzles that are tailored to the specific need.

The manifold is a length of piping having handles for the operator to grip and reliably use the system. The handles allow one or two man operation an allow use in a battering ram operation to drive the system through obstacles and into the combustion area. At the rear of the manifold a hammer cap is provided that allows the user to employ a sledge hammer or impact driver to assist in driving the system into the debris pile or fire area. Further, the manifold includes at least one NST fire hose adapter with a flow control valve to allow introduction of foam, water or fogging materials to the system via the manifold.

The manifold includes an output end that interfaces with a nozzle of any number of extension pipes. The interface is modular and threaded using NPTM threading to allow extensions to be added or removed depending on the depth of penetration required. Preferably the extensions are formed using high strength steel piping selected based on the design from Schedule 40, 80 and/or 120 pipe or heavier as needed.

The nozzles are designed for various specific purposes. A breaching and breaking nozzle is designed for penetration of structures walls and debris piles. While digging nozzles are designed to penetrate bulk material piles. The nozzles include various features such as flutes and forward directed ports that allow the use of high pressure water to aid in hydraulic boring to further assist and enhance penetration. Then water or other fire suppression agents can be delivered by adjusting various delivery flows at the manifold. The nozzles are interchangeable and can be tailored to suit the hazard being dealt with.

A further feature of the system is the provision of a retrieval chain secured to the hammer cap for easy of removing the unit from a pile or silo.

It is therefore an object of the present invention to provide a novel and improved fire extinguishing device that overcomes the aforementioned disadvantages and objections of the prior art devices. It is a further object of the present invention to provide a novel firefighting device which, in addition to its primary function of piercing a barrier can be employed in digging through bulk material for extinguishing fires hidden thereby or therein.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIGS. 1 and 2 are perspective views of the manifold of the firefighting system of the present invention;

FIGS. 3 and 4 are perspective views of the extension members for use with the manifold; and

FIGS. 5-14 are depictions of various nozzles for use with the system.

### DETAILED DESCRIPTION OF THE INVENTION

Now referring to the drawings, the firefighting agent delivery system is shown and generally illustrated in the figures. As can be seen the principal components of the system include a distribution manifold, a sectional delivery piping extension and interchangeable spray nozzles that are tailored to the specific need. These three components combine to provide an extendible firefighting nozzle and supply mechanism for use in penetrating materials and debris for fighting concealed fires in, for example, coal supply, bulk wood chip and combustible grain silo fire incidents. The system can be used to deliver firefighting foam, water and/or inert gas to the fire area. The components

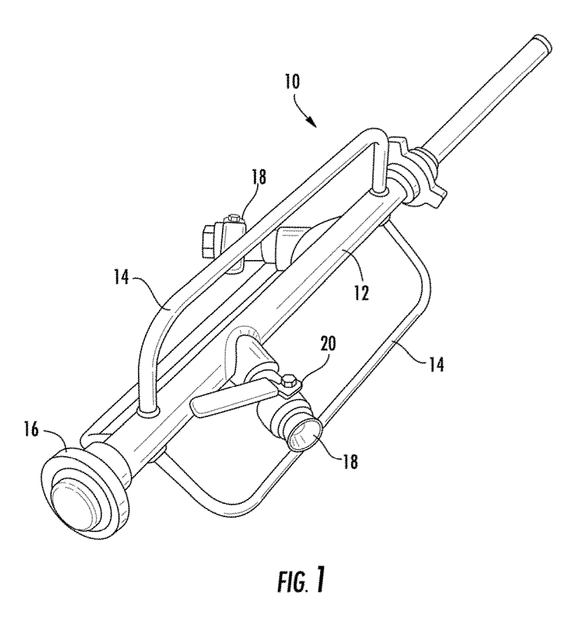

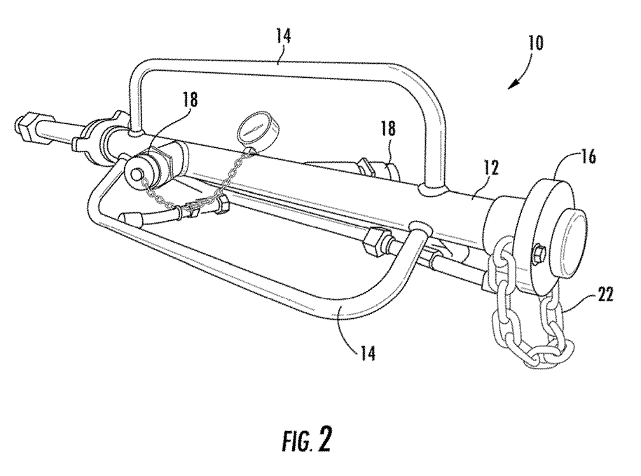

Turning to FIGS. 1 and 2, the manifold 10 is a length of piping 12 having at least one handle 14 for the operator to grip and reliably use the system. Preferably there are two or more handles 14 positioned about the manifold 10. The handles allow one or two man operation of the agent delivery system thereby making it easier to manage when in use. Further the handles 14 allow use in a battering ram operation to drive the system through obstacles and into the combustion area. At the rear of the manifold 10, a hammer cap 16 is provided that allows the user to employ a sledge hammer or impact driver to assist in driving the system into the debris pile or fire area. Further, the manifold 10 can be seen to include at least two standardized fire hose adapters 18 with flow control valves 20 to allow introduction of foam, water, fogging materials and combinations thereof into the system via the manifold 10.

A further feature of the system is the provision of a retrieval chain 22 secured to the hammer cap 16 for easy of removing the unit from a pile or silo.

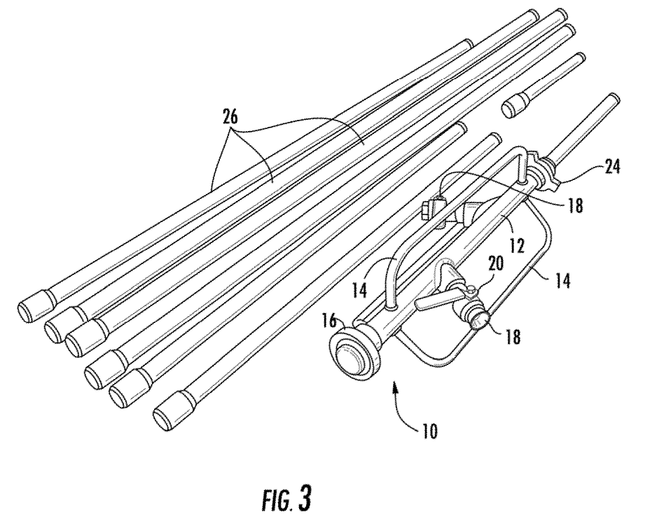

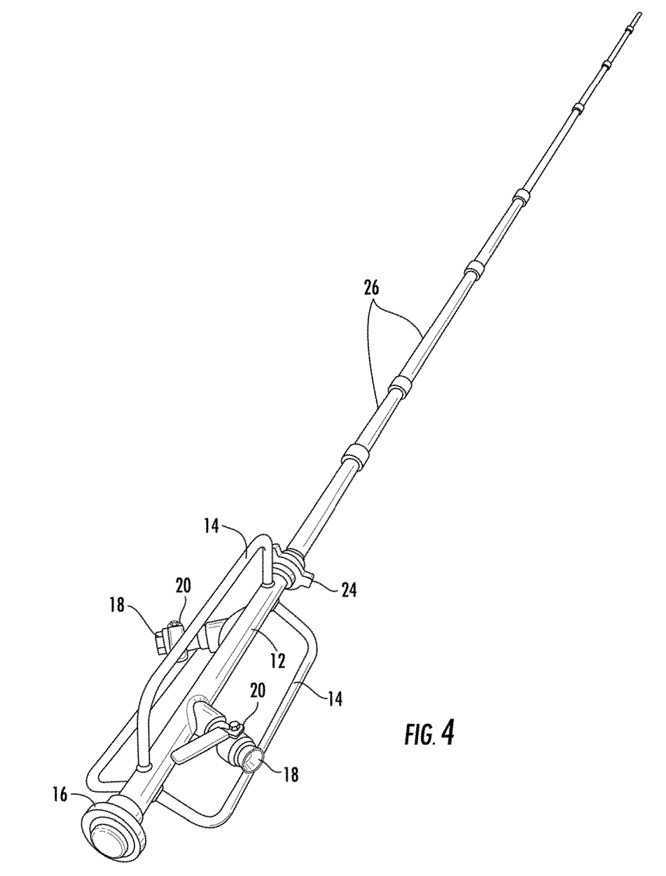

As can be seen in FIGS. 3 and 4, the manifold 10 includes an output end 24 that interfaces with a nozzle and any number of extension pipes 26. The output end 24 is modular and threaded using standardized NPTM threading to allow extension pipes 26 to be added or removed depending on the depth of penetration required. Preferably the extensions are formed using high strength steel piping selected based on the design from Schedule 40, 80 and/or 120 pipe, or heavier as needed.

While the use of fog streams and solid bore tips for interior attack and protection on fire exposures in open areas or non-defined confined spaces have been debated for years, all of the prior art devices provide for an indirect fire attack by use of the steam conversion technique using a fog pattern. The present disclosure provides for a direct attack with specific jet placement, direction, flow and pressure to the fire area. The designed effect of the present disclosure is to direct the flow of water/agent to gain the maximum use and effectiveness of each jet in the respective nozzles through the proper manifold and extension piping for the task at hand.

The manifolds and extension piping use a combination of gas and liquid thread sealing along with a specially designed retention system to prevent the parts from coming loose in the fire area. None of the prior art devices are used in subsurface injection for bulk storage fire control while the present disclosure has established several template nozzle designs and flow patterns, sizes, manifold layouts, etc. that operate specifically for subsurface fire control.

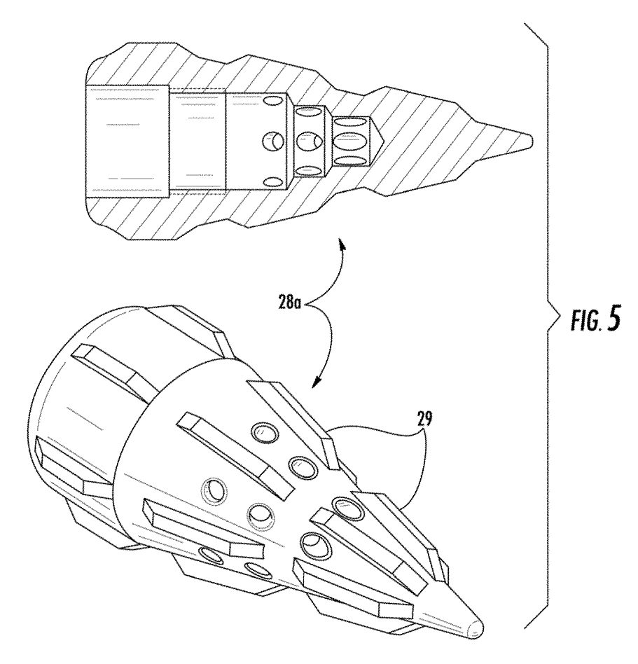

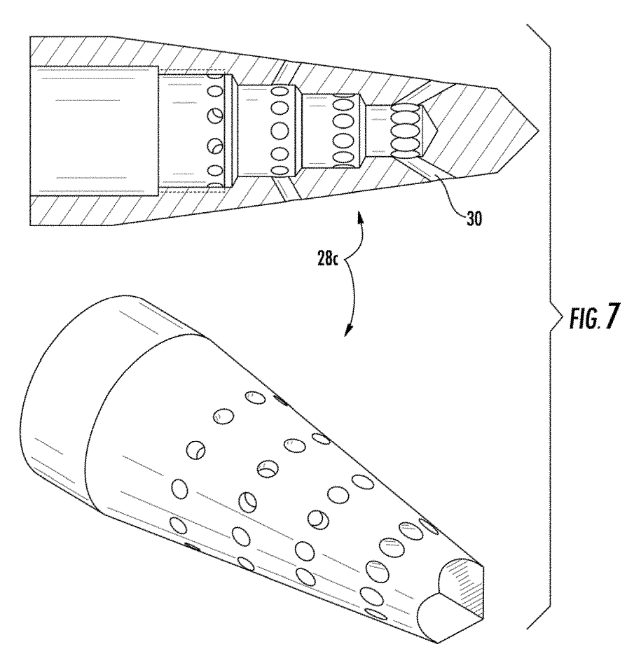

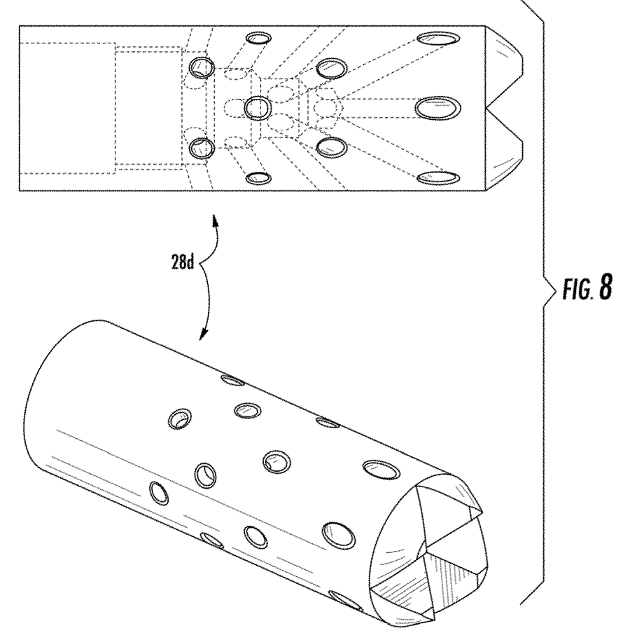

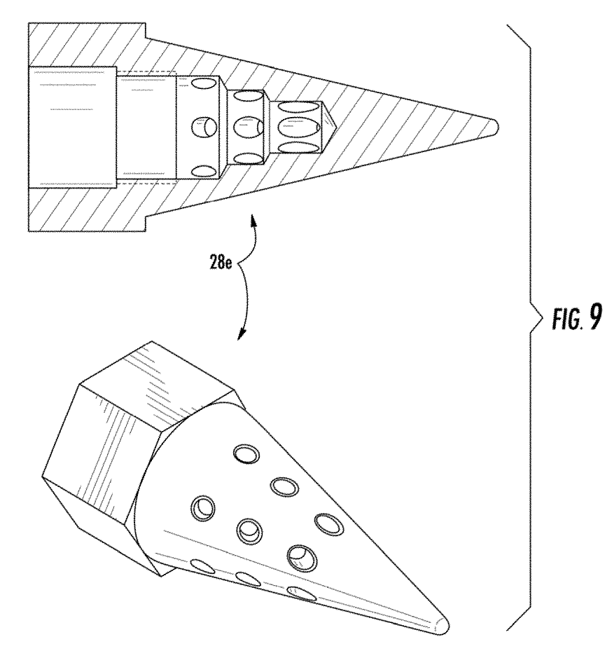

Turning to FIGS. 5-9 there are a variety of nozzles 28a, b, c, d and e, that are configured to be received at the output end of the manifold or at the end of one or more extension tubes. The nozzles are designed for various specific purposes such as breaching, breaking, boring, digging, penetrating and forward projections of penetrating water streams. A breaching and breaking nozzle 28a, 28c and 28e is designed for penetration of structures walls and debris piles. While digging nozzles 28b and 28d are designed to penetrate bulk material piles. The nozzles include various features such as flutes 29 and forward directed ports 30 that allow the use of high pressure water to aid in hydraulic boring to further assist and enhance penetration. Then water or other fire suppression agents can be delivered by adjusting various delivery flows at the manifold. The nozzles are interchangeable and can be tailored to suit the hazard being dealt with.

FIG. 5 depicts a fluted boring nozzle having 3 rows of forward facing jets at 15, 30 and 45 degrees spaced evenly between cutting edges. This nozzle is used to expand a bore hole diameter from 3-6 inches to 8-12 inches to allow larger timbers, footings or larger supporting structures to be installed for marine and dock construction. Also used in firefighting where larger flows and wider flow patterns are required for operational requirements. Jets exit the nozzle in a hexagonal pattern around the tip.

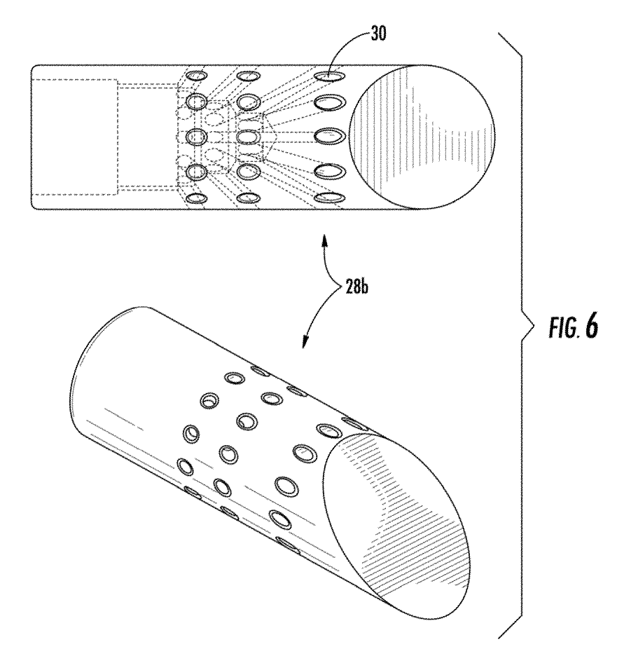

FIG. 6 depicts a chisel nozzle having 3 degree forward jet pattern designed to penetrate down the hole or in far reaching areas where expansion of the hole diameter is not indicated. Useful for digging out rocks in a blind hole or in a debris field. Jets exit the face of the nozzle only.

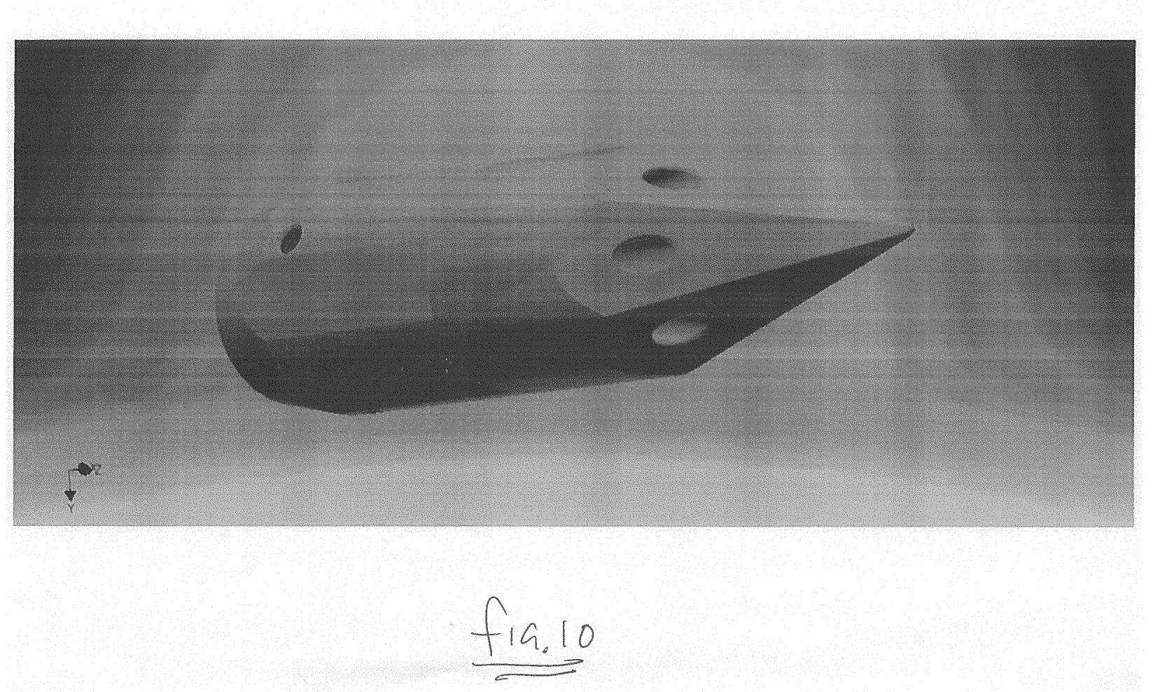

FIG. 10 is a marine/utility nozzle having a single row of 10-degree forward jets designed for use in the marine and utility industry where a small hole (2-3″) is desired for installing pilings or posts. Jets exit the nozzle in a hexagonal pattern around the tip.

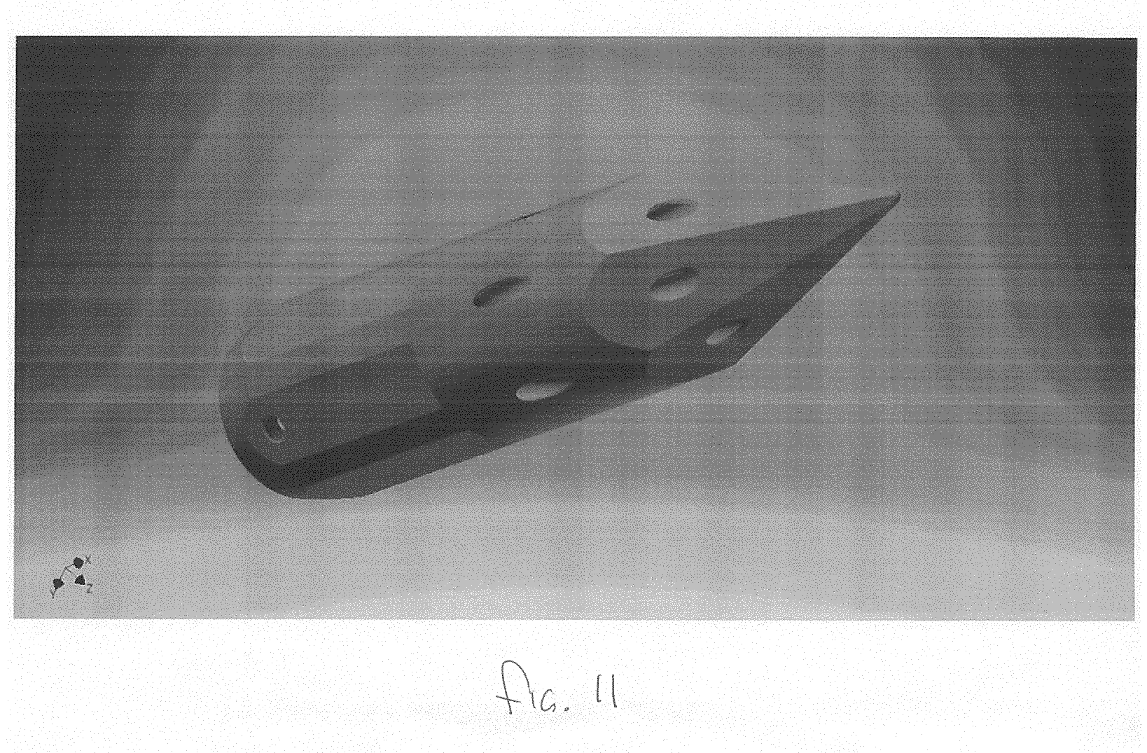

FIG. 11 is a spear nozzle that utilizes a double row of forward jets at 7.5 degree and 15-degree angles. Designed for use in the Wildland firefighting or construction use where a larger bore hole (3-4″) may be required, or a larger flow pattern is desirable. Jets exit the nozzle in a hexagonal pattern around the tip.

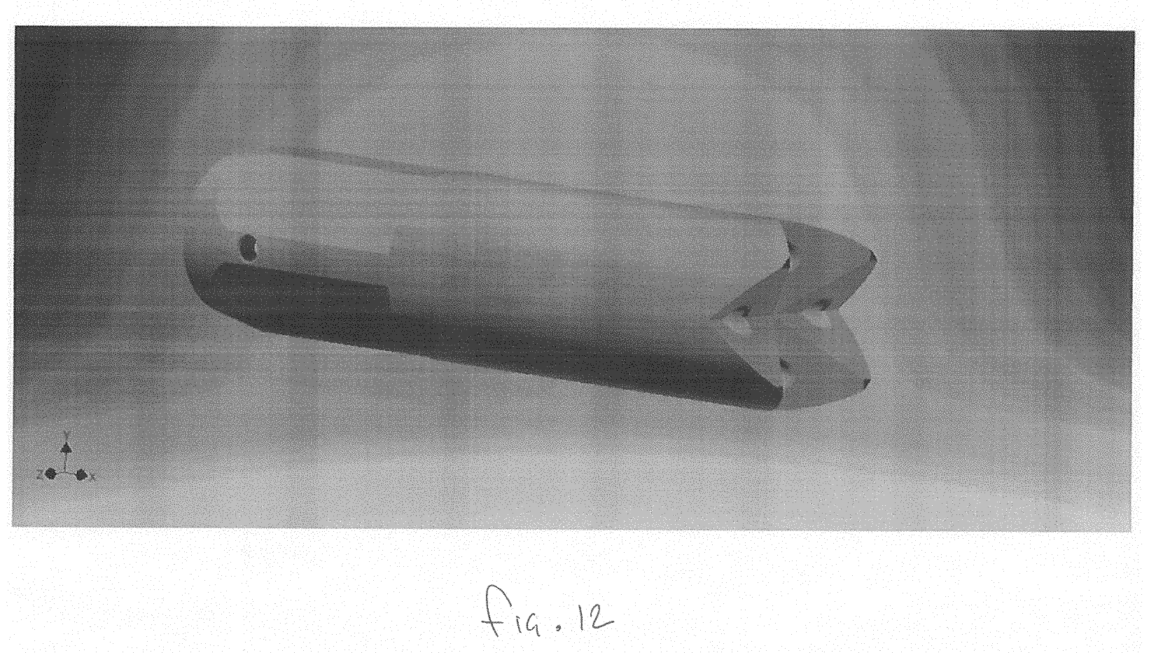

FIG. 12 is a breaching nozzle with a single row of 5-degree forward jets designed to allow for everyday tool use on the construction field where a low amount of residual material extracted from the hole is desired. Can be used in firefighting where an aggressive multi-tool nozzle is needed in debris fields. Jets exit the face of the nozzle only.

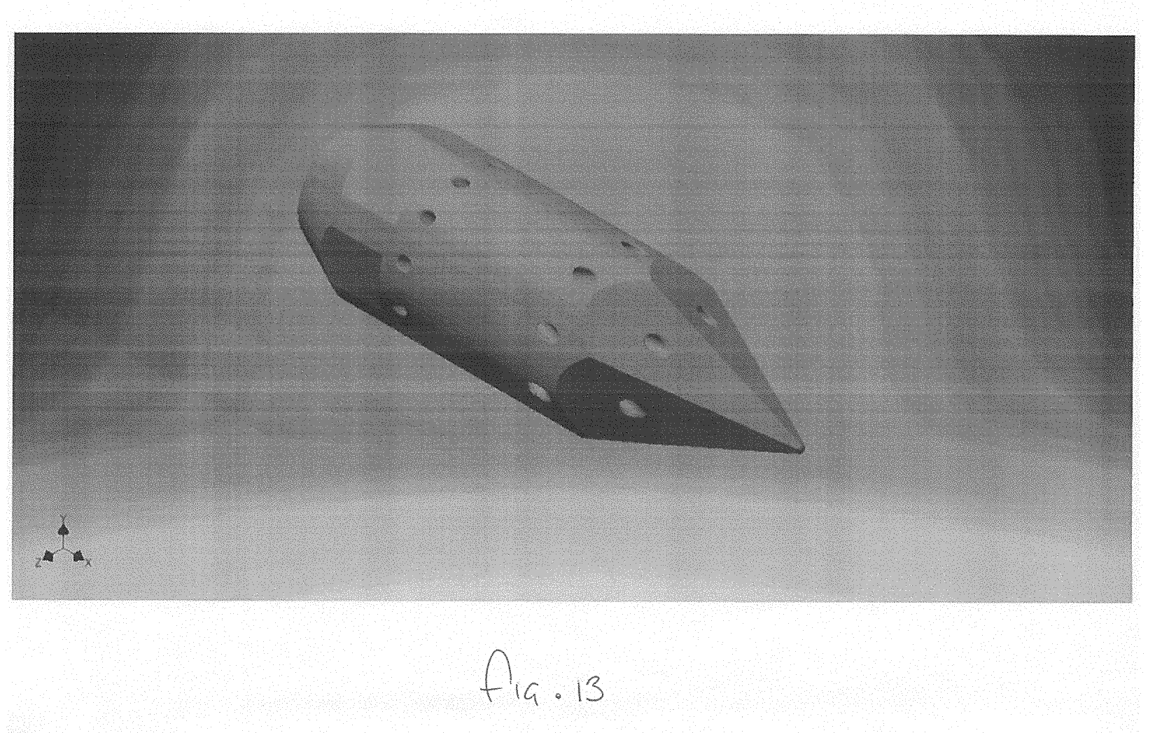

FIG. 13 is a dual flow nozzle having a double row of forward jets at 15 degrees and 30 degrees and 1 or more rows of rearward facing jets at jet angles of 30 degrees and/or 45 degrees. May be used in firefighting below a dock, deck or walkway, or used to clear out drainage pipes, septic outlets or pumping station reservoirs. Jets exit the nozzle in a hexagonal pattern around the tip and around the barrel circumference to the rear.

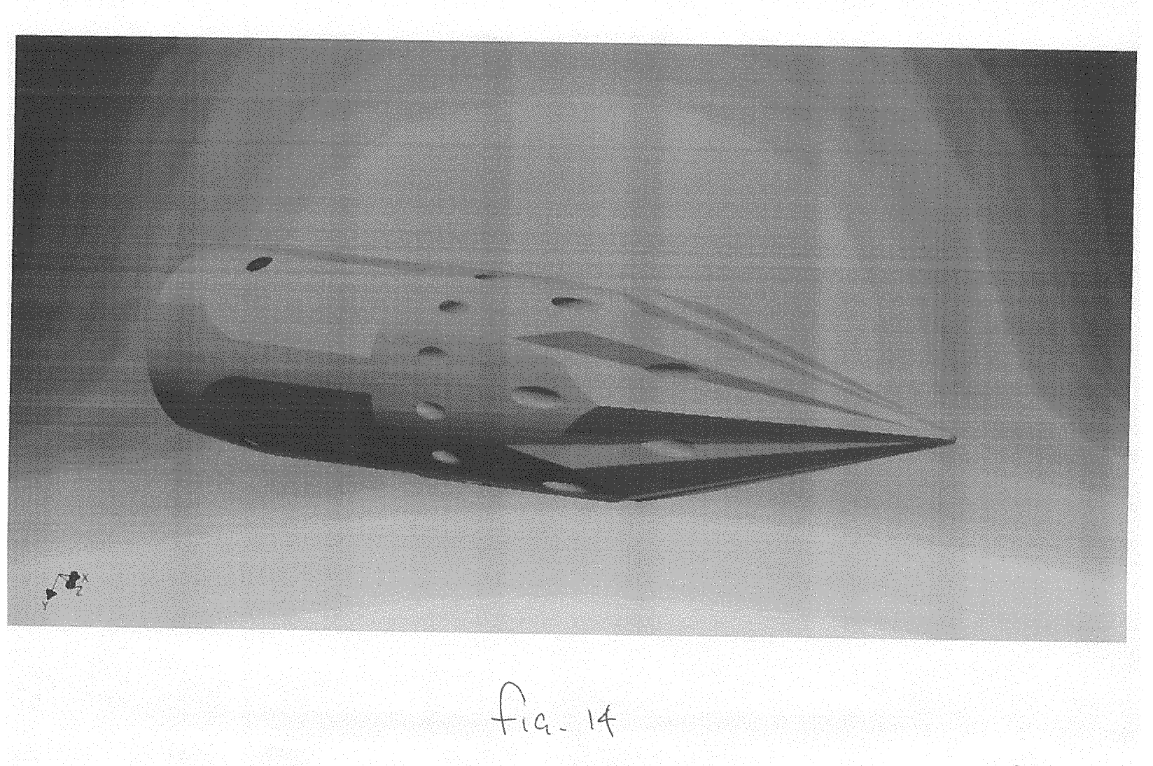

FIG. 14 provides a piercing nozzle with 3 to 5 rows of forward facing jets at angles of 7.5, 15, 22.5, 30 and 45 degrees depending on size and flow. Nozzle is machined in a pattern to punch through debris, concrete block, light gauge sheet metal, asphalt roofing and other construction materials in a “star” shaped pattern. Also use in the construction industry to bore holes from 5-6 inches for use installing pilings or posts. Jets exit the nozzle in a hexagonal pattern around the tip and around the barrel circumference in a layered and staggered pattern.

Finally an adjustable jet nozzle is disclosed having a custom design of various nozzle shapes and flows where customer has the option of changing the jetting pattern through the use of individual removable jets. By design only, but may mirror existing nozzle designs as described above.

The system is completely interchangeable and extendable, piercing type, low pressure/high flow jetting and agent application system. We have developed and customized this multi-use and versatile product line unlike any other equipment on the market today. By combining our team's vast experience in the emergency response, industrial and military markets with our engineering and design team, we are able to address any customer concern or need requiring this equipment.

Since this is a complete system, the added advantage of the multiple uses of this system is the adaptability to many other industries with the interchangeability of components that are built into each and every device. All of the manually operated 1-½″ components are interchangeable. As a result the device provides a variety of different manual tools for use in the fire service, public works, marine construction, well point insertion, recycling and coal storage industries and so on. The system specifications vary in size from ¾″ for manual wildland firefighting operations up to 4″ (or larger) for equipment mounted boring operations for bulk landfill, recycling and utility applications. For example; the system meets firefighter forcible entry needs, meets ARFF requirements of today's modern air freight carriers, can be used for coal storage sub-surface injection needs facilitates entry into overland or sea bound shipping containers on a freighter or for interior fire attack conditions on hazardous lightweight truss roof construction.

Coincidentally, these same fire protection products have found use in other niche industries that may use low pressure/high volume water jetting, drill well points or provide marine dock construction, utility connections and various dewatering operations and site work for construction, municipal and recycling center sites

It can therefore be seen that the present invention provides a novel and improved fire extinguishing device that overcomes the aforementioned disadvantages and objections of the prior art devices. Further, the present invention provides a novel firefighting device which, in addition to its primary function of piercing a barrier can be employed in digging through bulk material for extinguishing fires hidden thereby or therein. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A firefighting agent delivery system comprising:
a distribution manifold having at least one input and an output end and at least one handle extending from a side of said manifold,
a modular delivery piping extension comprising at least one removable pipe affixed to said output end of said manifold;
at least one interchangeable penetrating spray nozzle on said delivery piping opposite said manifold having directed jetted spray ports; and
a driving cap on an end of said manifold opposite said output end.

2. The system of claim 1, further comprising:
two or more handles extending from said manifold.

3. The system of claim 1, further comprising:
an extraction chain on an end of said manifold opposite said output end.

4. The system of claim 1, said at least one input further comprising:
at least two inputs each having a standardized fire hose fitting thereon.

5. The system of claim 4, said at least two inputs further comprising:
flow control valves thereon.

6. The system of claim 1, wherein said at least two inputs can be used to deliver a firefighting agent.

7. The system of claim 6, said firefighting agent being selected from the group consisting of: foam, water, fogging materials and combinations thereof.

8. The system of claim 1, said at least one nozzle selected form the group consisting of: breaching, breaking, boring, digging, penetrating and forward projections of penetrating water streams.
